(19) United States
(12) Patent Application Publication
(10) Pub. No.: US 2026/0128637 A1
(43) Pub. Date: May 7, 2026

(54) GROUNDING BRUSH ASSEMBLY

(71) Applicant: AKTIEBOLAGET SKF, GOTEBORG (SE)

(72) Inventors: Thomas PERROTIN, Saint Roch (FR); Emmanuel BENEVISE, Monts (FR); Kevin WATTIEAUX, Pernay (FR); Bruno CONSTANT, Tours (FR); Jean-Marie GERARD, Joué-Lès-Tours (FR); Benoit ARNAULT, Saint-Cyr-sur-Loire (FR)

(21) Appl. No.: 19/371,107

(22) Filed: Oct. 28, 2025

(30) Foreign Application Priority Data
Nov. 7, 2024 (FR) FR2412170

(51) Int. Cl. H02K 5/14; H02K 5/16; H02K 7/00; H02K 7/08; H02K 11/40

(52) U.S. Cl. CPC H02K 5/14; H02K 5/16; H02K 7/003; H02K 7/08; H02K 11/40

(57) ABSTRACT

A grounding brush assembly includes a grounding brush and a mounting plate for the brush, the brush being provided with a plurality of conductive fibers and with a support inside of which the conductive fibers are housed. The mounting plate is secured to the support and is provided with a radially extending main body, with retaining tongues for axially and radially holding the support, and with an axially extending centering portion. The mounting plate includes at least one bearing portion in radial abutment against the brush support and providing a bearing surface for a tool for inserting the assembly within a housing.

### CROSS-REFERENCE

This application claims priority to French patent application no. 2412170 filed on Nov. 7, 2024, the contents of which are fully incorporated herein by reference.

### BACKGROUND OF THE INVENTION

The present invention relates to grounding devices for controlling the shaft current generated in electric motors or machines, and more particularly to grounding brush assemblies.

In an electric motor or machine, at least one rolling bearing is mounted between the housing of the electric motor or machine and the rotary shaft in order to support this shaft.

In operation, when the shaft is rotating, a difference in electrical potential may arise between the shaft and the housing of the electric motor or machine, which may generate an electric current between the inner race of the rolling bearing, which is secured to the shaft, and the outer race secured to the housing.

Such an electric current passing through the components of the rolling bearing may damage these components, in particular the rolling elements and the raceways formed on the inner and outer races. Electrical discharges can also generate vibrations.

In order to remedy these drawbacks, it is a known practice to earth or ground the rotary shaft by using a grounding brush comprising conductive fibers. The grounding brush is generally mounted in the bore of the housing of the electric motor in such a way that the free ends of the fibers are in radial contact with the outer surface of the rotary shaft.

Due to the conductivity of the fibers, the brush is kept at the same electrical potential as the housing of the electric motor. The inner and outer races of the rolling bearing are also at the same electrical potential, which reduces or even eliminates problematic electrical discharges through the rolling bearing.

US Patent Publication No. 2021/0021180 A1 discloses a grounding brush assembly comprising a grounding brush provided with a support and with a plurality of conductive fibers mounted in this support, and an annular mounting plate provided with a plurality of tongues for radially and axially retaining the grounding brush support and with an annular outer flange radially surrounding the brush and the tongues. The tongues are formed by plastic deformation of the mounting plate.

Such a grounding brush assembly is force-fit into the bore of the housing, the grounding brush assembly therefore being difficult to remove.

### SUMMARY OF THE INVENTION

The present invention aims to remedy the drawback described above.

The invention relates to a grounding brush assembly for an electric motor provided with a rotating shaft, with a fixed housing and with a bearing.

The assembly comprises a grounding brush provided with a plurality of conductive fibers and with a support inside which the conductive fibers are mounted. The assembly also comprises a brush mounting plate which is secured to the support of the brush.

The mounting plate includes: a main body formed by a radial portion extending radially outwards with respect to the support; a plurality of centering tongues protruding axially with respect to the radial portion, each tongue locally radially surrounding the support of the brush and being in radial contact with the support, the support being held axially bearing against the radial portion of the mounting plate by the tongues; and a centering portion at least axially extending the main body, extending axially on the same side as the tongues, offset radially outwards with respect to the support and the tongues, and provided with an outer surface defining the outer diameter of the mounting plate in order to center the mounting plate after mounting in a bore of the housing of an associated electric motor.

According to a general feature of the invention, the mounting plate also includes at least one bearing portion protruding radially toward the inside of the assembly. The bearing portion is formed by a first bent portion extending axially from the main body and coming into radial abutment on an upper axial surface of the brush support, and by a second bent portion extending radially between the first bent portion and the centering portion, the second bent portion defining an axial bearing surface for a tool for positioning the assembly.

The centering portion and the first bent portion of the bearing portion both extend in the same axial direction from the main body. The centering portion is larger in diameter than the first bent portion, a radial offset being defined between these portions.

In one embodiment, the centering portion may be annular. Alternatively, the centering portion may comprise a plurality of axial portions spaced apart from one another in the circumferential direction.

In one embodiment, the mounting plate comprises a plurality of bearing portions spaced apart from one another in the circumferential direction.

In one embodiment, the retaining tongues and the bearing portions are distributed alternately in the circumferential direction.

In an advantageous embodiment, the second bent portion is continued by an axial portion of the centering portion.

The invention also relates to an electric machine or motor comprising a housing, a shaft, and a grounding brush assembly as defined above mounted at least partially radially between the housing and the shaft, the conductive fibers of the assembly being in contact with the shaft.

### BRIEF DESCRIPTION OF THE SEVERAL VIEWS OF THE DRAWINGS

The present invention will be better understood on studying the detailed description of embodiments, given by way of non-limiting example and illustrated by the appended drawings, in which:

FIG. 1 is a view in axial section of a grounding brush assembly mounted at least partially radially between a rotary shaft and a housing of an electric motor according to one exemplary embodiment of the invention;

FIG. 2 is a perspective view of the grounding brush assembly in FIG. 1;

FIG. 3 is a front view of the grounding brush assembly in FIG. 1;

FIG. 4 is a view in section of the assembly in FIG. 3 along line I-I;

FIG. 5 is a view in section of the assembly in FIG. 3 along line II-II;

FIG. 6 is a view in section of the assembly in FIG. 3 along line III-III; and

FIG. 7 is a front view of an alternative construction of the grounding brush assembly having a centering portion including a plurality of axial portions.

### DETAILED DESCRIPTION OF THE INVENTION

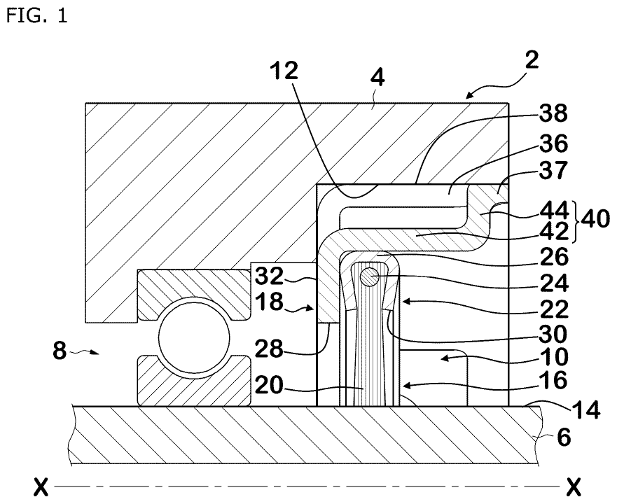

FIG. 1 shows, in axial section, part of an electric motor or machine 2 comprising a fixed housing 4, a rotary shaft 6 rotatable about a central axis X-X, and a bearing 8 radially supporting the shaft 6 and rotatably coupling the shaft 6 with the housing 4. The bearing 8 is preferably a ball bearing, but may have any other appropriate type of rolling element, such as for example, cylindrical rollers, tapered rollers, needles, etc. and may even be formed as a plain bearing.

The motor 2 comprises a grounding brush assembly 10 which is mounted at least partially radially between the bore 12 of the housing 4 and the outer cylindrical surface 14 of the shaft 6. The assembly 10 is, for example, force-fit within the bore 12 of the housing 4.

In the remainder of the description, the adjectives “axial” and “radial” and the adverbs “axially” and “radially” are defined with respect to the central axis X. Thus, an axial portion or part is parallel to the axis X, whereas a radial part or portion is perpendicular to this axis and surrounds the axis X. In addition, a radial portion is provided with an “inner” surface oriented towards the axis X, and with an “outer” surface oriented away from the axis X.

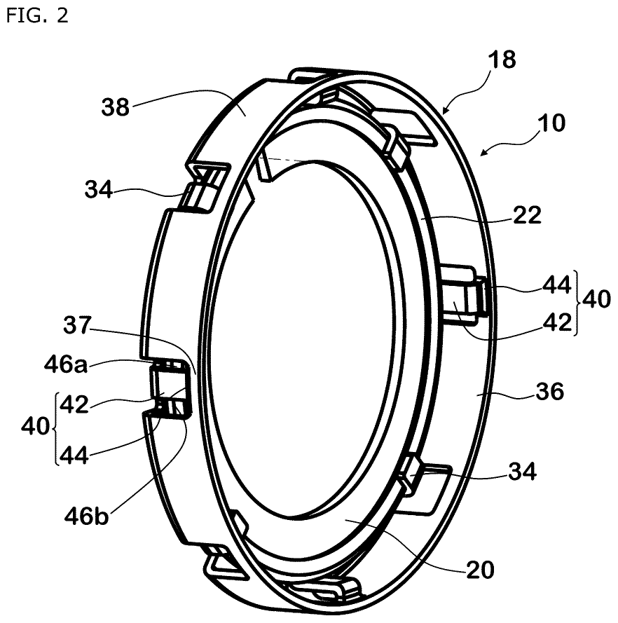

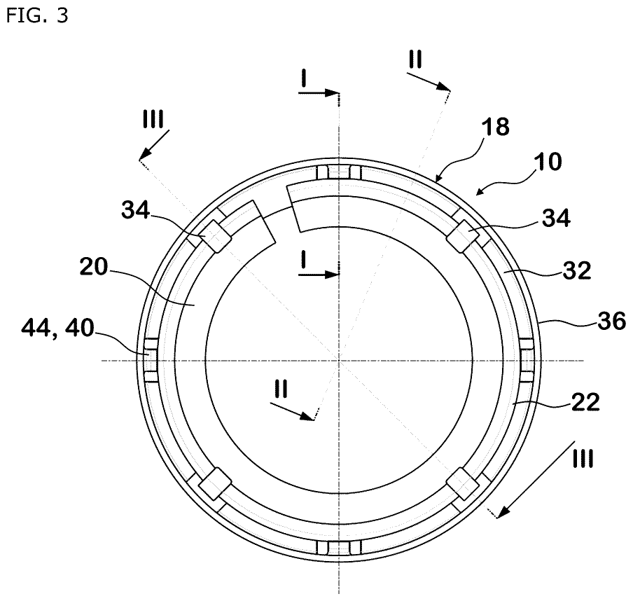

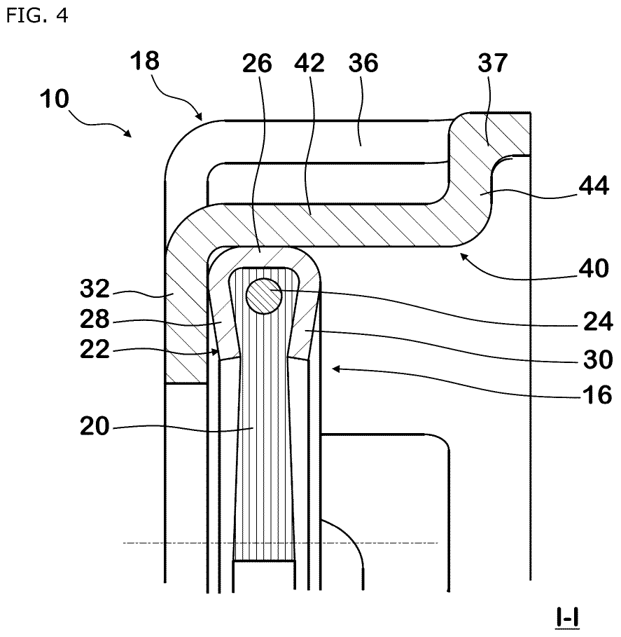

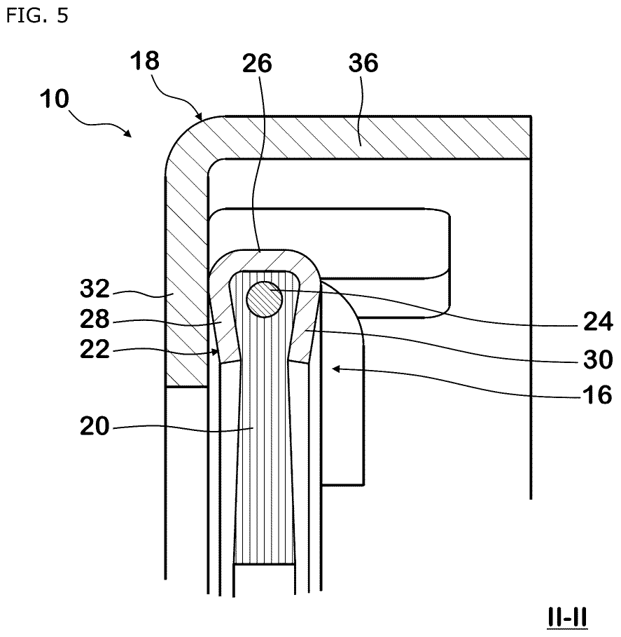

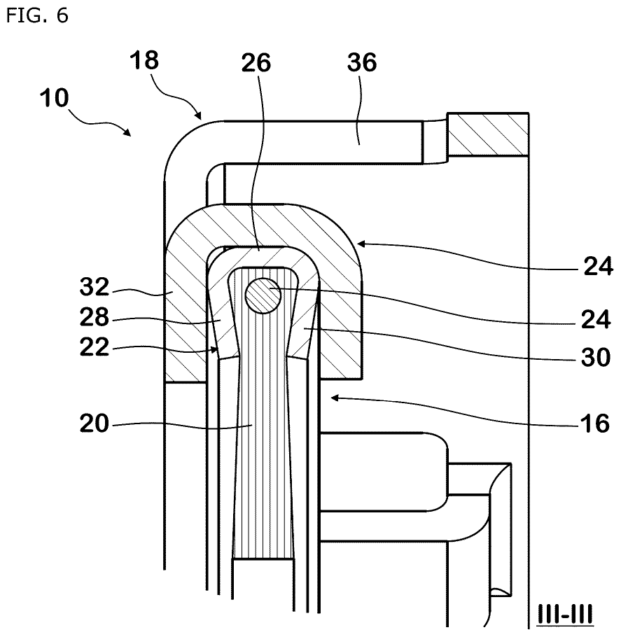

As best shown in FIGS. 2 to 6, the grounding brush assembly 10 has a generally annular shape. The assembly 10 basically comprises a grounding brush 16 and a mounting plate 18 for the brush 16.

The grounding brush 16 includes a plurality of conductive fibers 20 and a support 22, the conductive fibers 20 being housed or disposed at least partially within the support 22 of the brush 16. The conductive fibers 20 may be, for example, formed of carbon, stainless steel, conductive plastics, such as acrylic fibers or fibers made of nylon. The plurality of conductive fibers 20 are preferably in the form of an open ring. In the example illustrated, the conductive fibers 20 are bent around a connecting wire 24. The distal free ends of the conductive fibers 20 are intended to come into radial contact with the outer surface 14 of the shaft 6.

In order to ensure the mounting and the retention of the conductive fibers 20, the support 22 includes a cylindrical portion 26 defining an upper axial surface for the support 22, a first lateral edge 28 extending radially from one axial end of the cylindrical portion 26 and a second lateral edge 30 extending radially from an opposing axial end of the cylindrical portion 26. The second edge 30 is positioned axially toward the outside of the grounding brush assembly 10 and the first edge 28 is positioned axially toward the bearing 8, the edges 28, 30 being axially opposite with respect to the cylindrical portion 26 and the fibers 20.

The mounting plate 18 is secured to the support 22. The mounting plate 18 includes a main body 32 formed by a radial portion which is in axial abutment against the first edge 28 of the support 20, a plurality of tongues 34 for axially and radially retaining the brush 16 and an axial centering portion 36.

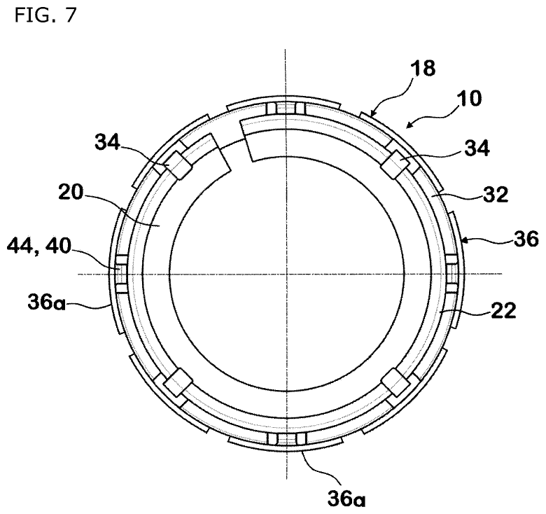

The centering portion 36 of the mounting plate 18 extends axially from the main body 32, in a direction generally away from the bearing 8. According to the embodiment illustrated in FIGS. 1 to 5, the centering portion 36 consists of an annular cylindrical portion. Alternatively, the centering portion 36 includes a plurality of axial portions 36a circumferentially spaced apart from each other, as shown in FIG. 7.

The centering portion 36 is provided with an outer surface 38 defining the outer diameter of the mounting plate 18 and is configured to center the mounting plate 18 after mounting the grounding brush assembly 10 within the bore 12 of the housing 4 of the associated electric motor 2. The centering portion 36 is preferably force-fit within the bore 12 of the housing 4 in order to create a diametral interference for ensuring the mechanical retention of the mounting plate 18 in the housing 4.

The retaining tongues 34 extend from the main body 32 of the mounting plate 18 and are spaced apart from each other in the circumferential direction. The tongues 34 protrude axially from the main body 32 in a direction away from the bearing 8.

Each retaining tongue 34 extends from the main body 32 of the mounting plate 18 such that the retaining tongue 34 locally radially surrounds the support 22 of the brush 16 while being in radial contact with the support 22. The support 22 is thereby held axially by the tongues 34. Furthermore, the tongues 34 are each provided with a bent edge on the support 22 in order to create an axial contact. The support 22 is held axially bearing against the radial portion 32 of the mounting plate 18 by the tongues 34. The support 22 is thus held axially and radially by the retaining tongues 34.

In the example shown, the mounting plate 18 includes four retaining tongues 34 spaced apart regularly or evenly in the circumferential direction. As a variant, the mounting plate 18 may include any other desired number of retaining tongues 34. If the mounting plate 18 includes a centering portion 36 formed as a plurality of axial portions 36a, the positions of the tongues 34 may alternate circumferentially with the axial portions 36a.

The centering portion 36 extends axially from the main body 32 on a same axial side of the body 32 as the brush support 22 and the tongues 34, and is offset radially outwardly with respect to the support 22 and the tongues 34.

The cylindrical portion 26 of the support 22 is in radial contact against the retaining tongues 34 and the second lateral edge 30 is in axial contact against the tongues 34. The cylindrical portion 26 extends axially from the large-diameter end of the first lateral edge 28. The cylindrical portion 26 preferably extends entirely axially.

The second lateral edge 30 of the brush support 22 extends radially inwardly from the cylindrical portion 26. Specifically, the second lateral edge 30 extends from the cylindrical portion 26 on the opposite side from the first lateral edge 28. The cylindrical portion 26 and the first and second lateral edges 28, 30 are each of annular shape and delimit a channel (not indicated) which is radially open on the inside, one end of the conductive fibers 20 being positioned within the channel. The first and second lateral edges 28, 30 axially clamp against the conductive fibers 20. The conductive fibers 20 are in axial abutment on each side against the first and second lateral edges 28, 30.

In the exemplary embodiment illustrated, the conductive fibers 20 come into radial abutment against the cylindrical portion 26, the first and second lateral edges 28, 30 extending obliquely inwards from the cylindrical portion 26. As a variant, the first and second lateral edges 28, 30 could extend entirely radially.

In the exemplary embodiment illustrated, the mounting plate 18 and the support 22 are two separate pieces. As a variant, the mounting plate 18 could be produced as a single piece or integrally formed with the support 22, for example produced by cutting and pressing (i.e., in a stamping operation). In this case, the main body 32 of the mounting plate 18 extends from the small-diameter border of the first lateral edge 28.

The mounting plate 18 and the grounding brush 16 are each preferably formed of an electrically conductive material, such as for example, aluminum, stainless steel, bronze, copper, a conductive polymer or any other appropriate material.

According to the present invention, the mounting plate 18 also comprises a plurality of bearing portions 40 for axially holding the brush support 22, and serving as a support for a tool for inserting the assembly 10 into a housing 4.

Each bearing portion 40 is preferably formed of a first bent portion 42 and a second bent portion 44. The first bent portion 42 extends axially from the main body 32. The centering portion 36 and the first bent portion 42 of the bearing portion 40 both extend in the same axial direction from the main body 32. The centering portion 36 is larger in diameter than the first bent portion 42, a radial offset being defined between the portions 36, 42.

The second bent portion 44 extends radially between the first bent portion 42 and the centering portion 36. The second bent portion 44 forms a radial connection between the two axial portions 42 and 36. Each bearing portion 40 thus forms a radial protrusion toward the inside of the assembly 10, i.e., with respect to the centering portion 36.

The second bent portion 44 is continued in an axial direction by an axial portion 37 of the centering portion 36. In other words, the axial portion 37 of the centering portion 36 extends axially from an outer radial end of the second bent portion 44.

Preferably, each bearing portion 40 is formed by cutting the centering portion 36. More specifically, two cuts 46a, 46b are made along a defined length and at a defined circumferential spacing through the thickness of the centering portion 36. The part between the two cuts 46a, 46b is then deformed by bending inwardly in order to form the two radially inwardly protruding portions 42 and 44. Alternatively, the bearing portions 40 may be produced by notching without removal of material.

According to the present invention, each first bent portion 42, which extends in an axial direction, comes into radial abutment on an upper axial surface of the cylindrical portion 26 of the brush support 22.

The support 22 is thus held radially in position by the plurality of bearing portions 40 and tongues 34 in direct contact with the outer surface of the cylindrical portion 26 of the support 22. Such radial holding of the support 22 is in combination with its axial holding between the tongues 34 and the main body 32, which ensures the support 22 is securely held in position with the mounting plate 18. Since the mounting plate 18 is itself fit within the bore 12 of the housing 4, the fibers 20 mounted in the support 22 are thus positioned with respect to the bearing 8, the housing 4, and the rotating shaft 6 in order to ensure one or more conductive paths for the passage of electric current.

In the example shown, the mounting plate 18 includes four bearing portions 40 spaced apart regularly or evenly in the circumferential direction. As a variant, the mounting plate 18 may include any desired number of the bearing portions 40.

In the example shown, the retaining tongues 34 and the bearing portions 40 are distributed alternately in the circumferential direction. As a variant, the tongues 34 and the bearing portions 40 may be arranged in any other appropriate manner, for example two or more bearing portions 40 being disposed between two circumferentially successive tongues 34, two or more tongues 34 being located between two successive bearing portions 40, etc.

Moreover, the second bent portion 44 of each bearing portion 40 defines an axial bearing surface for a tool (not illustrated) for positioning the assembly 10. By virtue of the invention, the grounding brush assembly 10 may be mounted in a simple manner and without risk of deformation within a housing 4 and upon a rotating shaft 6.

Indeed, prior art grounding brush assemblies, such as for example disclosed in US Patent Publication No. 2021/0021180, is force-fit within the bore of the housing by a mounting tool in axial abutment against the edges of the tongues and exerting a force in the axial direction of insertion. Such a method of mounting requires a suitable design of the grounding brush assembly, in particular a sufficient radial dimension of the tongues and of the support in order to withstand the force exerted thereon.

With the present invention, the grounding brush assembly 10 is force-fit within the bore 12 of the housing 4 by a mounting tool (not shown) in axial abutment against the lateral face of the second bent portion 44 of the bearing portions 40 and exerting a force in the axial direction of insertion. Consequently, the tongues 34 no longer have the function of supporting the tool, and can be dimensioned suitably solely for the function of retaining the support 22. The tongues 34 and the support 22 may be dimensionally reduced with respect to an assembly of the prior art, thereby enabling the assembly 10 to gain in radial compactness.

As a result, the tongues 34 and the support 22 are no longer subjected to a force exerted directly by the mounting tool, thus eliminating the risk of the parts deforming during the insertion of the assembly 10 within the housing 4.

The bearing portions 40 increase the rigidity of the centering portion 36, which is forcibly mounted in the housing 4. The risk of deforming the centering portion 36 during the fitting or removal of the assembly 10 is thereby reduced.

Furthermore, all or only some of the technical features of the various embodiments may be combined with one another. Thus, the grounding brush assembly 10 can be adapted or optimized in terms of cost, performance and ease of use.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A grounding brush assembly for an electric motor, the electric motor including a shaft rotatable about an axis, a fixed housing and a bearing coupling the shaft with the housing, the grounding brush comprising:
a grounding brush including a support and a plurality of conductive fibers disposed at least partially within the support; and
a brush mounting plate secured to the support of the brush and including a main body formed by a radial portion extending radially outwardly with respect to the support, a plurality of centering tongues protruding axially with respect to the main body, each centering tongue locally radially surrounding and in radial contact with the support of the brush such that the support is held axially bearing against the main body of the mounting plate by the tongues, a centering portion extending at least axially from the main body on a same axial side of the main body as the tongues and being offset radially outwardly with respect to the support and the tongues, the centering portion having an outer surface defining the outer diameter of the mounting plate and being configured to center the mounting plate within the bore of the housing of the electric motor, and at least one bearing portion including a first bent portion extending axially from the main body and radially abutting an upper axial surface of the brush support and a second bent portion extending radially between the first bent portion and the centering portion, the second bent portion having an axial bearing surface engageable by a tool for positioning the grounding brush assembly.

2. The assembly according to claim 1, wherein the centering portion is annular.

3. The assembly according to claim 1, wherein the centering portion includes a plurality of axial portions spaced circumferentially apart from each other.

4. The assembly according to claim 1, wherein the mounting plate includes a plurality of the bearing portions spaced circumferentially apart from each other.

5. The assembly according to claim 4, wherein the retaining tongues and the bearing portions are arranged alternating in the circumferential direction.

6. The assembly according to claim 1, wherein an axial portion of the centering portion extends from an outer radial end of the second bent portion.

7. The electric motor comprising:
a housing;
a shaft; and
a grounding brush assembly according to claim 1 mounted at least partially radially between the housing and the shaft, the conductive fibers of the assembly being in contact with the shaft.
